(19) United States
(12) Patent Application Publication
(10) Pub. No.: US 2026/0281320 A1
(43) Pub. Date: Sep. 17, 2026

(54) CROSS-COMPONENT PREDICTION

(71) Applicant: Tencent Technology (Shenzhen) Company Limited, Shenzhen (CN)

(72) Inventors: Renjie CHANG, Shenzhen (CN); Liqiang WANG, Shenzhen (CN); Xiaozhong XU, Shenzhen (CN)

(73) Assignee: Tencent Technology (Shenzhen) Company Limited, Shenzhen (CN)

(21) Appl. No.: 19/674,115

(22) Filed: May 11, 2026

Related U.S. Application Data
(63) Continuation of application No. PCT/CN2025/108498, filed on Jul. 14, 2025.

(30) Foreign Application Priority Data
Aug. 19, 2024 (CN) 202411139996.4

(51) Int. Cl. H04N 19/105; H04N 19/159; H04N 19/182; H04N 19/196

(52) U.S. Cl. CPC H04N 19/105; H04N 19/159; H04N 19/182; H04N 19/198

(57) ABSTRACT

Some aspects of the disclosure provide a method of cross-component prediction. In some examples, pixel values in a template area adjacent to a current block are obtained. The pixel values in the template area are adjusted according to an offset value to obtain adjusted pixel values. A cross-component prediction model for the current block is constructed based on the adjusted pixel values, model parameters of the cross-component prediction model are calculated based on division operations with numerators being left shifted a fixed number of bits. At least a chrominance component value of a pixel in the current block is generated according to the cross-component prediction model and reconstructed luminance component values of one or more pixels associated with the pixel in the current block. Apparatus and non-transitory computer-readable storage medium counterpart embodiments are also contemplated.

### RELATED APPLICATIONS

The present application is a continuation of International Application No. PCT/CN2025/108498, filed on Jul. 14, 2025, which claims priority to Chinese Patent Application No. 202411139996.4, filed on Aug. 19, 2024. The entire disclosures of the prior applications are hereby incorporated by reference.

### FIELD OF THE TECHNOLOGY

This disclosure relates to the field of computer and communication technologies, including a cross-component prediction method, a video coding and decoding method and apparatus, a medium and a device, a computer program product, and a method for storing a video bitstream.

### BACKGROUND

In the field of video coding and decoding, predictive coding may be performed by using a prediction model (for example, a nonlinear prediction model or a linear prediction model), and the prediction model usually needs to determine template parameters by using data in a template area.

A cross-component prediction technology is provided in related art, which uses data in the template area to perform cross-component prediction between brightness (also referred to as luminance) and chrominance. To obtain cross-component prediction with relatively high accuracy, those skilled in the art are further devoted to searching for various solutions of cross-component prediction.

### SUMMARY

Embodiments of this disclosure include a cross-component prediction method and a video coding and decoding method and apparatus, a medium and a device, so as to improve the precision of calculated model parameters, thereby being conducive to improving cross-component prediction accuracy and video coding and decoding performance.

Some aspects of the disclosure provide a method of cross-component prediction. In some examples, pixel values in a template area adjacent to a current block are obtained. The pixel values in the template area are adjusted according to an offset value to obtain adjusted pixel values. A cross-component prediction model for the current block is constructed based on the adjusted pixel values, model parameters of the cross-component prediction model are calculated based on division operations with numerators being left shifted a fixed number of bits. At least a chrominance component value of a pixel in the current block is generated according to the cross-component prediction model and reconstructed luminance component values of one or more pixels associated with the pixel in the current block.

Some aspects of the disclosure provide a method of video decoding. In some examples, a video bitstream is received, the video bitstream includes coded information of a current block. Pixel values in a template area adjacent to the current block are obtained. The pixel values in the template area are adjusted according to an offset value to obtain adjusted pixel values. A cross-component prediction model for the current block is constructed based on the adjusted pixel values, model parameters of the cross-component prediction model are calculated based on division operations with numerators being left shifted a fixed number of bits. At least a chrominance component value of a pixel in the current block is generated according to the cross-component prediction model and reconstructed luminance component values of one or more pixels associated with the pixel in the current block.

Some aspects of the disclosure provide a method of video encoding. In some examples, pixel values in a template area adjacent to a current block are obtained. The pixel values in the template area are adjusted according to an offset value to obtain adjusted pixel values. A cross-component prediction model for the current block is constructed based on the adjusted pixel values, model parameters of the cross-component prediction model are calculated based on division operations with numerators being left shifted a fixed number of bits. At least a chrominance component value of a pixel in the current block is generated according to the cross-component prediction model and reconstructed luminance component values of one or more pixels associated with the pixel in the current block. The current block is encoded into coded information in a video bitstream based on at least the chrominance component value of the pixel in the current block.

Some aspects of the disclosure provide an apparatus that includes processing circuitry configured to perform any of the methods described herein.

Some aspects of the disclosure provide a non-transitory computer-readable storage medium storing instructions which when executed by at least one processor cause the at least one processor to perform any of the methods described herein.

According to a first aspect, an embodiment of this disclosure provides a cross-component prediction method, which includes: obtaining a pixel value included in a template area adjacent to a current block; adjusting the pixel value in the template area according to a set offset value to obtain an adjusted pixel value; constructing a cross-component prediction model corresponding to the current block based on the adjusted pixel value; and generating a chrominance component predicted value corresponding to the current block according to the cross-component prediction model and a brightness component (also referred to as luminance component) reconstructed pixel corresponding to the current block.

According to a second aspect, an embodiment of this disclosure provides a video decoding method, which includes: decoding a video bitstream to obtain a pixel value included in a template area adjacent to a current block; adjusting the pixel value in the template area according to a set offset value to obtain an adjusted pixel value; constructing a cross-component prediction model corresponding to the current block based on the adjusted pixel value; and generating a chrominance component predicted value corresponding to the current block according to the cross-component prediction model and a brightness component reconstructed pixel corresponding to the current block, and performing decoding processing based on the chrominance component predicted value corresponding to the current block.

According to a third aspect, an embodiment of this disclosure provides a video coding method, which includes: obtaining a pixel value included in a template area adjacent to a current block; adjusting the pixel value in the template area according to a set offset value to obtain an adjusted pixel value; constructing a cross-component prediction model corresponding to the current block based on the adjusted pixel value; and generating a chrominance component predicted value corresponding to the current block according to the cross-component prediction model and a brightness component reconstructed pixel corresponding to the current block, and performing coding processing based on the chrominance component predicted value corresponding to the current block to obtain a coded video bitstream.

According to a fourth aspect, an embodiment of this disclosure provides a cross-component prediction apparatus, which includes: an obtaining unit, configured to obtain a pixel value included in a template area adjacent to a current block; an adjustment unit, configured to adjust the pixel value in the template area according to a set offset value to obtain an adjusted pixel value; a processing unit, configured to construct a cross-component prediction model corresponding to the current block based on the adjusted pixel value; and a generation unit, configured to generate a chrominance component predicted value corresponding to the current block according to the cross-component prediction model and a brightness component reconstructed pixel corresponding to the current block.

According to a fifth aspect, an embodiment of this disclosure provides a video decoding apparatus, which includes: a decoding unit, configured to decode a video bitstream to obtain a pixel value included in a template area adjacent to a current block; an adjustment unit, configured to adjust the pixel value in the template area according to a set offset value to obtain an adjusted pixel value; a processing unit, configured to construct a cross-component prediction model corresponding to the current block based on the adjusted pixel value; and a generation unit, configured to generate a chrominance component predicted value corresponding to the current block according to the cross-component prediction model and a brightness component reconstructed pixel corresponding to the current block, and perform decoding processing based on the chrominance component predicted value corresponding to the current block.

According to a sixth aspect, an embodiment of this disclosure provides a video coding apparatus, which includes: an obtaining unit, configured to obtain a pixel value included in a template area adjacent to a current block; an adjustment unit, configured to adjust the pixel value in the template area according to a set offset value to obtain an adjusted pixel value; a processing unit, configured to construct a cross-component prediction model corresponding to the current block based on the adjusted pixel value; and a coding unit, configured to generate a chrominance component predicted value corresponding to the current block according to the cross-component prediction model and a brightness component reconstructed pixel corresponding to the current block, and perform coding processing based on the chrominance component predicted value corresponding to the current block to obtain a coded video bitstream.

According to a seventh aspect, an embodiment of this disclosure provides a computer-readable medium, which has a computer program stored therein, and the computer program, when executed by a processor (an example of processing circuitry), implements the cross-component prediction method, the video decoding method, or the video coding method as described in the above embodiments.

According to an eighth aspect, an embodiment of this disclosure provides an electronic device, which includes: one or more processors; and a storage apparatus, configured to store one or more computer programs, and the one or more computer programs, when executed by the one or more processors, causes the electronic device to implement the cross-component prediction method, the video decoding method, or the video coding method as described in the above embodiments.

According to a ninth aspect, an embodiment of this disclosure provides a computer program product. The computer program product includes a computer program, and the computer program is stored in a computer-readable storage medium (e.g., non-transitory computer-readable storage medium). A processor of an electronic device reads the computer program from the computer-readable storage medium, and executes the computer program to cause the electronic device to implement the cross-component prediction method, the video decoding method, or the video coding method provided in various embodiments mentioned above.

According to a tenth aspect, an embodiment of this disclosure provides a method for storing a video bitstream. The video bitstream is stored on a non-volatile computer-readable storage medium, and the video bitstream is generated according to the foregoing coding method or is decoded based on the foregoing decoding method.

The foregoing general descriptions and the following detailed descriptions are explanatory and are not intended to limit this disclosure.

### BRIEF DESCRIPTION OF THE DRAWINGS

FIG. 1 shows a schematic diagram of a system architecture that may apply technical solutions in embodiments of this disclosure.

FIG. 2 shows a schematic diagram of a placement mode of a video coding apparatus and a video decoding apparatus in a streaming transmission system.

FIG. 3 shows a basic flowchart of a video coder.

FIG. 4 shows a flowchart of cross-component nonlinear prediction.

FIG. 5 shows a schematic diagram of sampling points used in a cross-component nonlinear prediction process.

FIG. 6 shows a flowchart of a cross-component prediction method according to an embodiment of this disclosure.

FIG. 7 shows a schematic diagram of pixel values in an adjacent area on which an offset value is generated according to an embodiment of this disclosure.

FIG. 8 shows a flowchart of a video decoding method according to an embodiment of this disclosure.

FIG. 9 shows a flowchart of a video coding method according to an embodiment of this disclosure.

FIG. 10 shows a block diagram of a cross-component prediction apparatus according to an embodiment of this disclosure.

FIG. 11 shows a block diagram of a video decoding apparatus according to an embodiment of this disclosure.

FIG. 12 shows a block diagram of a video coding apparatus according to an embodiment of this disclosure.

FIG. 13 shows a schematic structural diagram of a computer system suitable for implementing an electronic device according to an embodiment of this disclosure.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

In addition, the features, structures, or characteristics described in this disclosure may be combined in one or more embodiments in any proper mode. In the following descriptions, many specific details are provided for understanding of the embodiments of this disclosure. However, when implementing the technical solutions in this disclosure, not all features in the embodiments are needed, one or more specific details may be omitted, or other methods, elements, apparatuses, steps, and the like may be used.

In the embodiments of this disclosure, the term “module” or “unit” refers to a computer program with a preset function or a part of the computer program and works together with other related parts to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including the module or unit function.

The block diagrams shown in the accompanying drawings are functional entities and do not necessarily correspond to physically independent entities. To be specific, the functional entities may be implemented in a software form, or in one or more hardware modules or integrated circuits, or in different networks and/or processor apparatuses and/or microcontroller apparatuses.

The flowcharts shown in the accompanying drawings are descriptions, and do not necessarily include all content and operations/steps, nor do they have to be executed in the described order. For example, some operations/steps may further be broken down, but some operations/steps may be merged or partially merged. Therefore, an actual execution order may change according to an actual situation.

“A plurality of” mentioned herein means two or more. The “and/or” describes an association relationship between associated objects and represents that three relationships may exist. For example, A and/or B may represent the following three cases: only A exists, both A and B exist, and only B exists. The character “/” generally represents an “or” relationship between the associated objects.

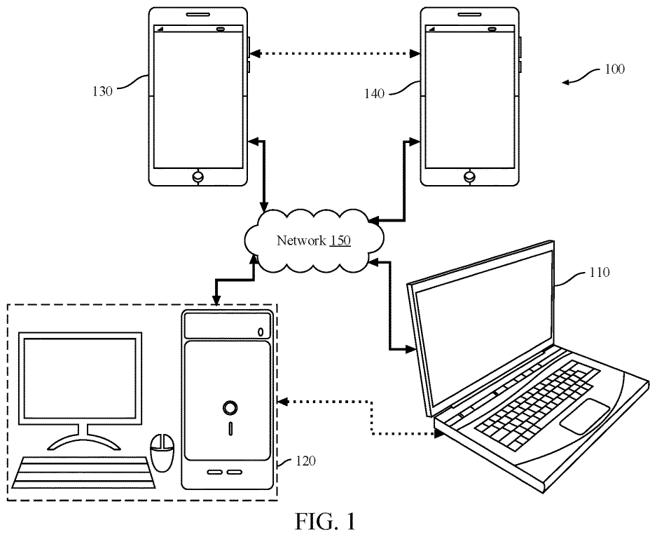

FIG. 1 shows a schematic diagram of a system architecture that may apply technical solutions in embodiments of this disclosure.

As shown in FIG. 1, a system architecture 100 includes a plurality of terminal apparatuses, and the terminal apparatuses may communicate with each other through, for example, a network 150. For example, the system architecture 100 may include a first terminal apparatus 110 and a second terminal apparatus 120 that are interconnected through the network 150. In the embodiment of FIG. 1, the first terminal apparatus 110 and the second terminal apparatus 120 perform unidirectional data transmission.

For example, the first terminal apparatus 110 may code video data (for example, a video picture stream collected by the terminal apparatus 110) for transmission to the second terminal apparatus 120 through the network 150. The coded video data is transmitted in a form of one or more coded video bitstreams, and the second terminal apparatus 120 may receive the coded video data from the network 150, decode the coded video data to recover the video data, and display a video picture according to the recovered video data.

In an embodiment of this disclosure, the system architecture 100 may include a third terminal apparatus 130 and a fourth terminal apparatus 140 that perform bidirectional transmission of the coded video data. The bidirectional transmission may occur, for example, during a video conference. For bidirectional data transmission, each of the third terminal apparatus 130 and the fourth terminal apparatus 140 may code video data (for example, a video picture stream collected by the terminal apparatus) for transmission to the other one of the third terminal apparatus 130 and the fourth terminal apparatus 140 through the network 150. Each of the third terminal apparatus 130 and the fourth terminal apparatus 140 may further receive the coded video data transmitted by the other one of the third terminal apparatus 130 and the fourth terminal apparatus 140, decode the coded video data to recover video data, and display a video picture on an accessible display apparatus according to the recovered video data.

In the embodiment shown in FIG. 1, the first terminal apparatus 110, the second terminal apparatus 120, the third terminal apparatus 130, and the fourth terminal apparatus 140 may be servers or terminals, but the principle disclosed in this disclosure may not be limited thereto.

The server may be an independent physical server, or a server cluster or a distributed system including a plurality of physical servers, or a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The terminal may be a smartphone, a tablet computer, a notebook computer, a desktop computer, a smart speaker, a smart voice interaction device, a smart watch, a smart household appliance, an on-board terminal, an aircraft, or the like, which is not limited thereto.

The network 150 shown in FIG. 1 represents any number of networks for transmitting the coded video data among the first terminal apparatus 110, the second terminal apparatus 120, the third terminal apparatus 130, and the fourth terminal apparatus 140, and includes, for example, a wired and/or wireless communication network. The communication network 150 may exchange data in a circuit switching and/or packet switching channel. The network may include a telecommunication network, a local area network, a wide area network, and/or the Internet. For the purpose of this disclosure, unless explained below, an architecture and a topology of the network 150 may be inconsequential to operations disclosed in this disclosure.

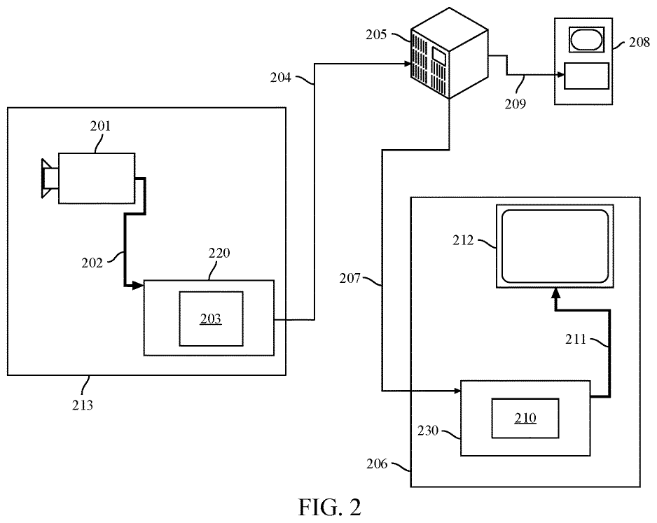

In an embodiment of this disclosure, FIG. 2 shows a placement mode of a video coding apparatus and a video decoding apparatus in a streaming transmission environment. The subject disclosed in this disclosure may be equally applicable to other applications supporting videos, including, for example, a video conference, a digital television (TV), and storage of a compressed video on a digital medium such as a compact disc (CD), a digital versatile disc (DVD), or a memory stick.

A streaming transmission system may include a collection subsystem 213. The collection subsystem 213 may include a video source 201 such as a digital camera. The video source creates an uncompressed video picture stream 202. In an embodiment, the video picture stream 202 includes a sample shot by the digital camera. Compared with the coded video data 204 (or the coded video bitstream 204), the video picture stream 202 is drawn as a bold line to emphasize a video picture stream with a high data volume. The video picture stream 202 may be processed by an electronic apparatus 220. The electronic apparatus 220 includes a video coding apparatus 203 coupled to the video source 201. The video coding apparatus 203 may include hardware, software, or a combination of software and hardware to achieve or implement various aspects of the disclosed subject described in more detail below. Compared with the video picture stream 202, the coded video data 204 (or the coded video bitstream 204) is drawn as a thin line to emphasize the coded video data 204 (or the coded video bitstream 204) with a relatively low data volume, which may be stored on a streaming transmission server 205 for future use. One or more streaming transmission client subsystems, for example, a client subsystem 206 and a client subsystem 208 in FIG. 2, may access the streaming transmission server 205 to retrieve a copy 207 and a copy 209 of the coded video data 204. The client subsystem 206 may include, for example, a video decoding apparatus 210 in an electronic apparatus 230. The video decoding apparatus 210 decodes the incoming copy 207 of the coded video data, and generates an output video picture stream 211 that may be presented on a display 212 (for example, a display screen) or another presentation apparatus. In some streaming transmission systems, the coded video data 204, video data 207, and video data 209 (for example, video bitstreams) may be coded according to some video coding/compression standards.

The electronic apparatus 220 and the electronic apparatus 230 may include other components not shown in the figure. For example, the electronic apparatus 220 may include a video decoding apparatus, and the electronic apparatus 230 may further include a video coding apparatus.

In an embodiment of this disclosure, by taking high efficiency video coding (HEVC) and versatile video coding (VVC) in international video coding standards, and the Chinese national video coding standard AVS as examples, after a video frame of image is inputted, the video frame of image is partitioned into several non-overlapping processing units according to a block size, and a similar compression operation is performed on each processing unit. The processing unit is referred to as a coding tree unit (CTU) or a largest coding unit (LCU). The CTU may be further partitioned more finely to obtain one or more basic coding units (CUs). The CU is the most basic element in a coding section.

In another embodiment, the processing unit may also be referred to as a tile, which is a rectangular area of a multimedia data frame that may be independently decoded and coded. In an alliance for open media video 1 (AV1) standard formulated by the alliance for open media, a tile may be further partitioned more finely to obtain one or more superblocks (SBs). The SB is a starting point of block partition and may be further partitioned into a plurality of subblocks, and then, the SB is further partitioned to obtain one or more blocks. Each block is the most basic element in a coding section. In some embodiments, one SB may include a plurality of blocks (Bs).

The foregoing partition mode for the video frame of image may be referred to as a block partition structure. The following introduces some concepts in a coding process.

Predictive Coding: Predictive coding includes modes such as intra prediction and inter prediction. A residual video signal is obtained after an original video signal is predicted through a selected reconstructed video signal. A coding side needs to determine which predictive coding mode to select for a current coding unit (or coding block), and informs a decoding side. The intra prediction means that a predicted signal is from an area that has been reconstructed by coding in the same image. The inter prediction means that a predicted signal is from another coded image (referred to as a reference image) different from a current image.

Transform & Quantization: After a residual video signal undergoes transform operations such as discrete Fourier transform (DFT) and discrete cosine transform (DCT), the signal is converted into a transform domain, which is referred to as a transform coefficient. Lossy quantization is further performed on the transform coefficient to lose certain information, so that a quantized signal is beneficial to compression and expression. In some video coding standards, more than one transform mode may be selected. Therefore, the coding side also needs to select one transform mode for the current coding unit (or coding block), and informs the decoding side. Quantization fineness is usually determined by a quantization parameter (QP). A relatively large value of the QP indicates that coefficients within a relatively large value range are quantized into the same output, therefore, relatively large distortion and a relatively low bit rate are usually caused. On the contrary, a relatively small value of the QP indicates that coefficients within a relatively small value range are quantized into the same output, therefore, relatively small distortion is usually caused, and a corresponding relatively high bit rate is also caused.

Entropy coding or statistical coding: Statistical compression coding is performed on a quantized transform domain signal according to a frequency at which each value appears, and finally, a binary (0 or 1) compressed bitstream is outputted. Meanwhile, other information, such as a selected coding mode and motion vector data, is generated through coding, and entropy coding also needs to be performed to reduce a bit rate. Statistical coding is a lossless coding mode, and may effectively reduce a bit rate required for expressing the same signal. A common statistical coding mode includes variable length coding (VLC) or content adaptive binary arithmetic coding (CABAC).

A CABAC process mainly includes three operations: binarization, context modeling, and binary arithmetic coding. After binarization processing is performed on an inputted syntactic element, binary data may be coded by using a related coding mode and a bypass coding mode. In the bypass coding mode, a particular probability model does not need to be allocated to each binary bit, and an inputted binary bit bin value is directly coded by using a simple bypass coder, so as to accelerate entire coding and decoding. Generally, different syntactic elements are not independent of each other, and the same syntactic element also has certain memorization. Therefore, according to the conditional entropy theory, conditional coding is performed by using another coded syntactic element, and the coding performance may be further improved compared with independent coding or memoryless coding. The coded symbol information used as a condition is referred to as a context. In a related coding mode, binary bits of a syntactic element sequentially enter a context modeling device. A coder assigns an appropriate probability model to each inputted binary bit according to a value of a syntactic element or a binary bit that has been coded previously. This process is context modeling. A context model corresponding to a syntactic element may be located by using a context index increment (ctxIdxInc) and a context index Start (ctxIdxStart). After the bin value and the assigned probability model are both transmitted to a binary arithmetic coder for coding, the context model needs to be updated according to the bin value, which is an adaptive process during coding.

Loop Filtering: A reconstructed image is obtained by performing operations of inverse quantization, inverse transform, and predictive compensation on a signal after change and quantization. The reconstructed image has a quantization impact compared with the original image, and some information is different from that in the original image, that is, the reconstructed image may generate distortion. Therefore, a filter operation may be performed on the reconstructed image, for example, a filter such as a deblocking filter (DB), a sample adaptive offset (SAO), or an adaptive loop filter (ALF), so as to effectively reduce a distortion degree generated by quantization. Because these filtered reconstructed images are used as the reference for subsequent coded images to predict a future image signal, the foregoing filter operation is also referred to as loop filtering, that is, a filter operation in a coding loop.

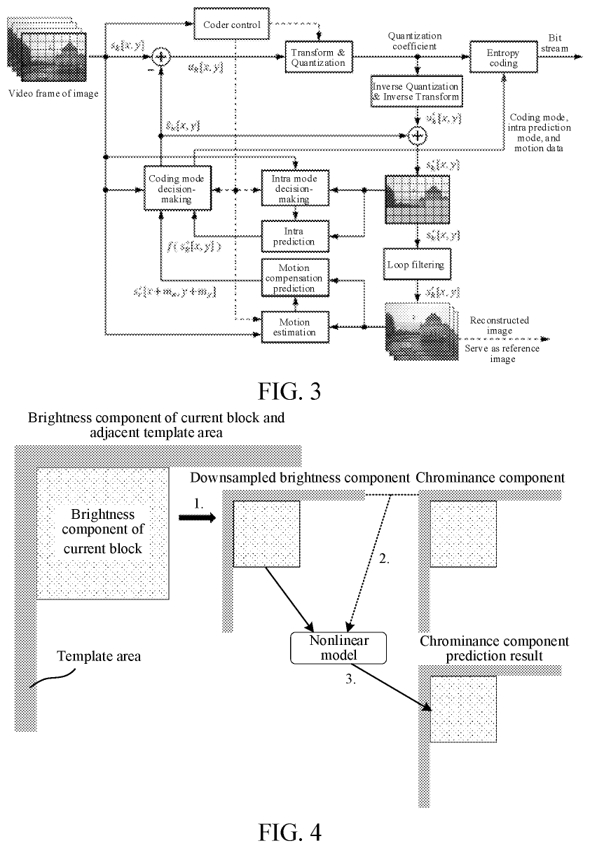

In an embodiment of this disclosure, FIG. 3 shows a basic flowchart of a video coder. In this process, intra prediction is taken as an example for description. An original image signal sₖ[x, y] and a predicted image signal ŝₖ[x, y] are subjected to a difference operation to obtain a residual signal uₖ[x, y], and after the residual signal uₖ[x, y] is subjected to transform and quantization, a quantization coefficient is obtained. On one hand, entropy coding is performed on the quantization coefficient to obtain a coded bit stream; and on the other hand, inverse quantization and inverse transform are performed on the quantization coefficient to obtain a reconstructed residual signal u′ₖ[x, y], and the predicted image signal ŝₖ[x, y] is superimposed with the reconstructed residual signal u′ₖ[x, y] to generate an image signal

$${s}_{k}^{*} [ x , y ] .$$

On one hand, the image signal

$${s}_{k}^{*} [ x , y ]$$

is inputted into an intra mode decision-making module and an intra prediction module for intra prediction processing; and on the other hand, a reconstructed image signal s′ₖ[x, y] is outputted by loop filtering, and the reconstructed image signal s′ₖ[x, y] may be used as a reference image of a next frame for motion estimation and motion compensation prediction. Then, based on a motion compensation prediction result s′ᵣ[x+mₓ, y+m_{y}] and an intra prediction result

$$f ( {s}_{k}^{*} [ x , y ] ) ,$$

a predicted image signal ŝₖ[x, y] of a next frame is obtained, and the foregoing process is repeated until coding is completed.

Based on the foregoing coding process, on the decoding side, for each coding unit (or coding block), after a compressed bitstream (i.e., a bit stream) is obtained, entropy decoding is performed to obtain various mode information and quantization coefficients. Then, inverse quantization and inverse transform processing are performed on the quantization coefficient to obtain a residual signal. On the other hand, according to known coding mode information, a predicted signal corresponding to the coding unit (or the coding block) may be obtained, then a reconstructed signal may be obtained after the residual signal and the predicted signal are added, and then the reconstructed signal is subjected to operations such as loop filtering to generate a final output signal. In this series of coding processes, a coding framework mainly makes a decision according to rate-distortion optimization (RDO) to select an optimal coding parameter.

The following introduces some prediction models used in a prediction process in video coding.

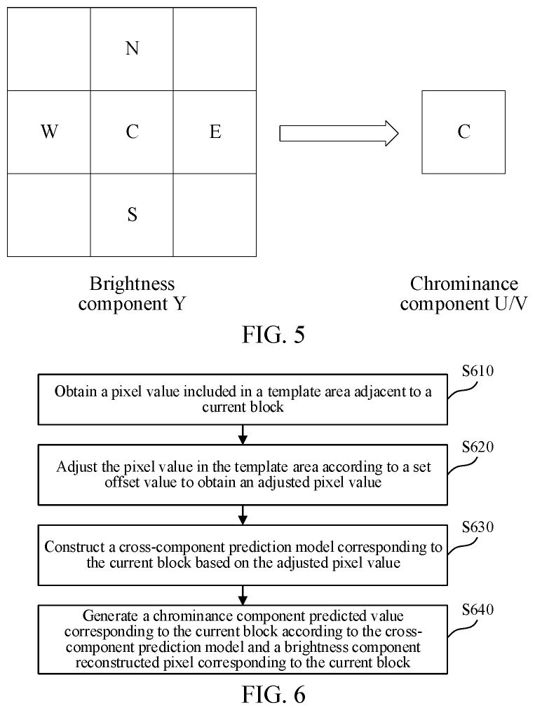

A cross-component nonlinear intra prediction model (CCNPM) is formed by constructing a cross-component prediction model of a brightness component and a chrominance component based on adjacent pixels of a current block, and then using reconstructed brightness component pixels of the current block to perform intra chrominance component prediction. FIG. 4 shows a prediction process of the CCNPM, which includes the following three operations:
(1) Downsample a brightness component of a current block and a template area (i.e., a grayscale area shown in FIG. 4, including a reconstructed pixel area in a left column, a reconstructed pixel area in an upper row, and a pixel area at an upper left corner) adjacent to the current block, so as to obtain a downsampled brightness component.
(2) Construct a cross-component nonlinear prediction model between a brightness component (Y) and a chrominance component (U/V) according to the adjacent template area. As shown in FIG. 5, the cross-component nonlinear prediction model uses a location C corresponding to a chrominance component (U/V) sampling point in the downsampled brightness component (Y) and surrounding downsampled brightness component sampling points (W, N, S, E). Based on these sampling points obtained in the template area, the following nonlinear model structure may be constructed:

$${C}^{′} = {p}_{0} ( \frac{N + S + 4 C + W + E}{8} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + 4 C + W + E}{8} )}^{2} + {p}_{6} B$$

where C′ represents a target chrominance component sampling point, pᵢ (i.e., p₀, p₁, p₂, p₃, p₄, p₅, and p₆) represents a model parameter, and B represents a constant term. A model parameter of the CCNPM may be obtained by solving a plurality of nonlinear model equations.

In some examples, in a process of solving the model coefficient, multiple times of multiplication and division operations are performed based on a brightness sampling point and a chrominance sampling point in the template area. The higher the precision of the multiplication and division operations is, the more accurate and effective the model coefficient obtained by solving is. When the division operation is performed, to improve the calculation precision, the CCNPM uses a mode of moving a numerator leftwards by a fixed number of bits (for example, moving the numerator leftwards by 22 bits, left-shifting 22 bits) to scale up the numerator. Finally, when chrominance prediction is performed, the sampling point of the target chrominance is then moved rightwards by the fixed number of bits (for example, the result is moved rightwards by 22 bits) to restore to an original value range.
(3) After the model parameter of the CCNPM is obtained, input a downsampled brightness component sampling point corresponding to the current block into the cross-component prediction model, so as to obtain a chrominance component predicted value.

The size of a template area adjacent to the CCNPM is 6 lines for chrominance and 12 lines for brightness (using a YUV420 format as an example), that is, a maximum required line buffer is 12 lines.

The CCNPM can be applied not only to intra prediction, but also to inter prediction. Therefore, the CCNPM may also be referred to as a cross-component nonlinear prediction model. Alternatively, the cross-component nonlinear prediction model applied to the inter prediction may be represented as inter CCNPM, and the principle thereof is consistent with that of the CCNPM applied to the intra prediction.

A cross-component linear model (CCLM) is another prediction model. Similar to the CCNPM, the CCLM is also formed by constructing a cross-component prediction model by using a brightness component reference pixel and a chrominance component reference pixel in an adjacent template area, and then calculating a chrominance component predicted value according to a brightness component reconstructed value of a current block. A difference lies in that a prediction model constructed by the CCLM is a linear model. A linear prediction model of the CCLM may be represented as:

$$p r e {d}_{C} ( i , j ) = α \cdot {rec}_{L}^{′} ( i , j ) + β$$

where pred_{c}(i, j) represents a current chrominance component prediction point with coordinates (i, j),

$${rec}_{L}^{′} ( i , j )$$

represents a current brightness component reconstructed pixel point obtained after downsampling, and α and β are respectively model parameters.

Although a cross-component prediction model, for example, the CCNPM or the CCLM, brings an appreciable coding gain, there is some space to improve the calculation precision. To further improve the coding performance, in the embodiments of this disclosure, an offset value of a particular magnitude is applied to a sample used by the cross-component prediction model to improve the precision of the model parameter obtained through calculation, thereby improving the calculation precision of the cross-component prediction to further improve the coding and decoding performance.

The following describes implementation details of the technical solutions in the embodiments of this disclosure in further detail.

FIG. 6 shows a flowchart of a cross-component prediction method according to an embodiment of this disclosure. The cross-component prediction method may be performed by a video coding device or a video decoding device. The video coding device or the video decoding device may be a terminal device, a server, or the like. As shown in FIG. 6, the cross-component prediction method includes at least S610 to S640. A description is as follows:
S610: Obtain a pixel value included in a template area adjacent to a current block.

In some embodiments, a video includes a video image frame sequence. The video image frame sequence includes a series of images, each image may be further partitioned into slices, the slices may further be partitioned into a series of LCUs (or CTUs), and the LCU includes a plurality of CUs. A video image frame is coded by using a block as a unit during coding. In some new video coding standards, for example, the H.264 standard includes a macroblock (MB), and the MB may be further partitioned into a plurality of prediction blocks that may be configured for predictive coding. In the HEVC standard, basic concepts such as a coding unit (CU), a prediction unit (PU), and a transform unit (TU) are adopted to partition various block units in function, and a brand-new tree-based structure is adopted for description. For example, a CU may be partitioned into smaller CUs according to a quadtree, and the smaller CUs may further be partitioned to form a quadtree structure. The current block in the embodiments of this disclosure may be a CU or a block smaller than the CU, for example, a smaller block obtained by partitioning the CU.

In some embodiments, the template area adjacent to the current block is configured to construct the cross-component prediction model, and the template area may include an area located on a left side of the current block and an area located at an upper side of the current block, or may include the area located on the left side of the current block, or include the area located at the upper side of the current block. Alternatively, the template area may include an area in another direction of the current block, for example, an upper right area.
S620: Adjust the pixel value in the template area according to a set offset value to obtain an adjusted pixel value. Herein, certain offset is applied to the pixel value in the template area to be used, so as to improve the calculation precision of the cross-component prediction model, thereby improving the accuracy of the cross-component prediction.

In some embodiments, the set offset value may be a set constant value, that is, the set constant value may be used as an offset value to adjust the pixel value in the template area. In some embodiments, the set constant value may be, for example, a value such as 0, 64, 128, 256, 512, or 1024, or may be another value. For example, the set constant value may be a decimal value.

In some embodiments, the set offset value may also be generated according to pixel values in an adjacent area of the current block. For example, an average pixel value in the adjacent area of the current block may be calculated, and the calculated average pixel value is used as the offset value. Alternatively, statistical processing may be performed on the pixel values in the adjacent area of the current block by using another mathematical algorithm. For example, weighted summation is performed by using a set weight value, or a median of the pixel values in the adjacent area of the current block is used as the set offset value.

In some embodiments, the pixel values in the adjacent area of the current block include one or more of the following pixel values: a first quantity of pixel values closely adjacent to an upper left corner of the current block; a second quantity of pixel values closely adjacent to a lower left corner of the current block; a third quantity of pixel values closely adjacent to an upper right corner of the current block; a fourth quantity of pixel values closely adjacent to a lower right corner of the current block; a fifth quantity of pixel values closely adjacent to an upper side of the current block; a sixth quantity of pixel values closely adjacent to a left side of the current block; a seventh quantity of pixel values closely adjacent to a right side of the current block; an eighth quantity of pixel values closely adjacent to a lower side of the current block; a ninth quantity of pixel values spaced apart from the upper left corner of the current block by a first set distance; a tenth quantity of pixel values spaced apart from the lower left corner of the current block by a second set distance; an eleventh quantity of pixel values spaced apart from the upper right corner of the current block by a third set distance; a twelfth quantity of pixel values spaced apart from the lower right corner of the current block by a fourth set distance; a thirteenth quantity of pixel values spaced apart from the upper side of the current block by a fifth set distance; a fourteenth quantity of pixel values spaced apart from the left side of the current block by a sixth set distance; a fifteenth quantity of pixel values spaced apart from the right side of the current block by a seventh set distance; and a sixteenth quantity of pixel values spaced apart from the lower side of the current block by an eighth set distance.

In some embodiments, the first quantity, the second quantity, the third quantity, the fourth quantity, the fifth quantity, the sixth quantity, the seventh quantity, the eighth quantity, the ninth quantity, the tenth quantity, the eleventh quantity, the twelfth quantity, the thirteenth quantity, the fourteenth quantity, the fifteenth quantity, and the sixteenth quantity in the foregoing embodiments may be equal, or may not be equal, or may be partially equal, for example, may be selected from values such as 1, 2, 3, 4, 5, and 6.

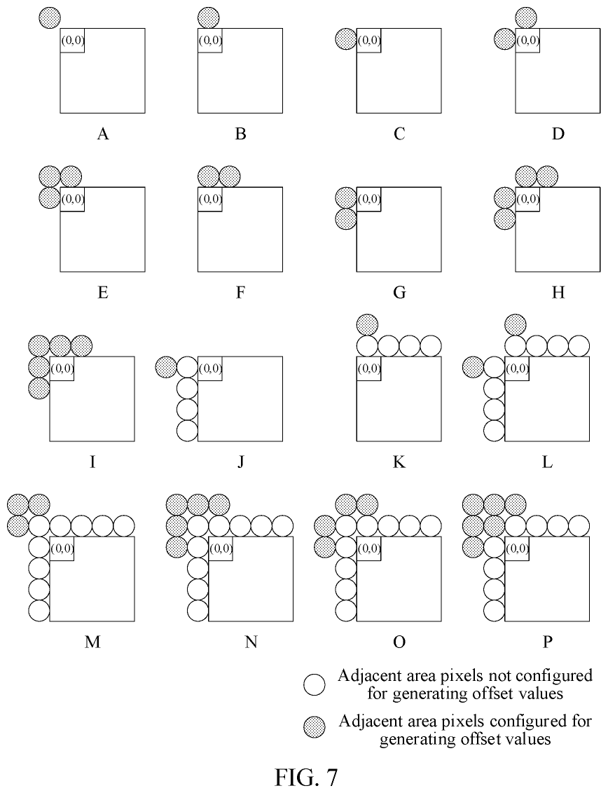

For example, in the embodiment shown in FIG. 7, the pixel values in the adjacent area of the current block on which the offset value is generated may include one pixel value closely adjacent to the upper left corner of the current block shown in figure A in FIG. 7; or may include one pixel value closely adjacent to the upper side of the current block shown in figure B in FIG. 7; or may include one pixel value closely adjacent to the left side of the current block shown in figure C in FIG. 7; or may include one pixel value closely adjacent to the upper side of the current block and one pixel value closely adjacent to the left side of the current block shown in figure D in FIG. 7; or may include one pixel value closely adjacent to the upper side of the current block, one pixel value closely adjacent to the left side of the current block, and one pixel value closely adjacent to the upper left corner of the current block shown in figure E in FIG. 7; or may include two pixel values closely adjacent to the upper side of the current block shown in figure F in FIG. 7; or may include two pixel values closely adjacent to the left side of the current block shown in figure G in FIG. 7; or may include two pixel values closely adjacent to the left side of the current block and two pixel values closely adjacent to the upper side of the current block shown in figure H in FIG. 7; or may include two pixel values closely adjacent to the left side of the current block, two pixel values closely adjacent to the upper side of the current block, and one pixel value closely adjacent to the upper left corner of the current block shown in figure I in FIG. 7; or may include a pixel value spaced apart from the left side of the current block by one pixel shown in figure J in FIG. 7; or may include a pixel value spaced apart from the upper side of the current block by one pixel shown in figure K in FIG. 7; or may include a pixel value spaced apart from the left side of the current block by one pixel and a pixel value spaced apart from the upper side of the current block by one pixel shown in FIG. 1 in FIG. 7; or may include three pixel values spaced apart from the upper left corner of the current block shown in figure M in FIG. 7; or may include pixel values spaced apart from the left side, upper side and upper left corner of the current block shown in figure N and figure O in FIG. 7; or may include a pixel value (of a pixel that is) spaced apart from the left side, upper side and upper left corner of the current block and a pixel value closely adjacent to the upper left corner of the current block shown in figure P in FIG. 7.

The embodiments shown in FIG. 7 are examples. In other embodiments of this disclosure, the examples shown in FIG. 7 may be combined together as pixel values in an adjacent area of a current block on which an offset value is generated. In addition, in other embodiments of this disclosure, the pixel values in the adjacent area of the current block on which the offset value is generated may also be pixel values adjacent to the current block, or pixel values in other directions or other quantities spaced apart from the current block.

In some embodiments, when the pixel value in the template area is adjusted according to the set offset value, a mathematical operation may be performed on the pixel value in the template area by using the offset value to obtain the adjusted pixel value. For example, the offset value may be added, subtracted, multiplied, or divided from the pixel value in the template area, or the offset value may be applied to the pixel value in the template area in one or more modes of these mathematical operations, so as to obtain the adjusted pixel value.

In some embodiments, when the pixel value in the template area is adjusted according to the set offset value, the set offset value may be adjusted to obtain a new offset value, and then, the pixel value in the template area is adjusted by using the new offset value to obtain the adjusted pixel value.

In some embodiments, when the offset value is adjusted, linear adjustment may be performed on the offset value based on a set linear function to obtain the new offset value; or, nonlinear adjustment may be performed on the offset value based on a set nonlinear function to obtain the new offset value.

In some embodiments, the set offset value may include a brightness component offset value and a chrominance component offset value. The brightness component offset value is configured for adjusting a brightness component pixel value, and the chrominance component offset value is configured for adjusting a chrominance component pixel value. In some embodiments, the brightness component offset value and the chrominance component offset value may be the same or may be different. During actual applications, the brightness component offset value and the chrominance component offset value may be exported by using the technical solution in the foregoing embodiment.
S630: Construct a cross-component prediction model corresponding to the current block based on the adjusted pixel value.

In some embodiments, for a process of constructing a cross-component prediction model corresponding to the current block based on the adjusted pixel value, referring to a process shown in FIG. 4, a similar method may be adopted for both a linear prediction model and a nonlinear prediction model.

If the cross-component prediction model includes a constant term, the constant term may also be offset by using a set constant offset value.
S640: Generate a chrominance component predicted value corresponding to the current block according to the cross-component prediction model and a brightness component reconstructed pixel corresponding to the current block.

In some embodiments, if the constructed cross-component prediction model includes the chrominance component offset value, that is, the chrominance component offset value has been used as a parameter to be added to the cross-component prediction model, the brightness component reconstructed pixel corresponding to the current block may be inputted into the cross-component prediction model, so as to obtain the chrominance component predicted value corresponding to the current block outputted by the cross-component prediction model.

In some embodiments, if the cross-component prediction model does not include the chrominance component offset value, that is, the chrominance component offset value is not used as a parameter to be added to the cross-component prediction model, when the chrominance component predicted value corresponding to the current block is generated, the brightness component reconstructed pixel corresponding to the current block may be inputted into the cross-component prediction model, and then, the chrominance component predicted value corresponding to the current block is generated based on the chrominance component offset value and a predicted value outputted by the cross-component prediction model.

In some embodiments, the cross-component prediction model in the embodiments of this disclosure may be: a cross-component nonlinear prediction model for intra prediction, a cross-component linear prediction model for intra prediction, a cross-component nonlinear prediction model for inter prediction, and a cross-component linear prediction model for inter prediction. In other words, the cross-component prediction model in the embodiments of this disclosure not only may be a nonlinear prediction model, but also may be a linear prediction model, and not only may be applied to intra prediction, but also may be applied to inter prediction.

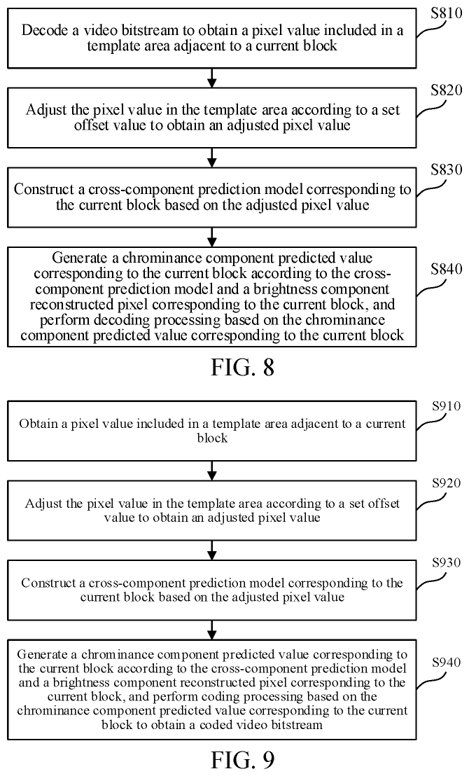

Based on the cross-component prediction method shown in FIG. 6, an embodiment of this disclosure further provides a video decoding method. The video decoding method may be performed by a device having a computing function, for example, may be performed by a terminal device or a server. A specific process is shown in FIG. 8, including S810 to S840, and is described as follows:
S810: Decode a video bitstream to obtain a pixel value included in a template area adjacent to a current block.
S820: Adjust the pixel value in the template area according to a set offset value to obtain an adjusted pixel value.
S830: Construct a cross-component prediction model corresponding to the current block based on the adjusted pixel value.
S840: Generate a chrominance component predicted value corresponding to the current block according to the cross-component prediction model and a brightness component reconstructed pixel corresponding to the current block, and perform decoding processing based on the chrominance component predicted value corresponding to the current block.

For processing details of the operations shown in FIG. 8, refer to the introduction in the foregoing embodiments, and details are not described herein again. Meanwhile, a video decoding side (i.e., a video decoding device) may determine a mode for exporting the offset value according to a mode negotiated with a coding side (i.e., a video coding device). Alternatively, the video decoding side may decode the video bitstream to obtain at least one flag bit, then determine whether to adjust the pixel value in the template area by using the offset value according to a value of the at least one flag bit, and determine a mode for exporting the offset value when the pixel value in the template area is adjusted by using the offset value.

In some embodiments, the mode for exporting the offset value is whether the offset value is generated by using a set constant value or according to pixel values in the adjacent area of the current block introduced in the foregoing embodiment. If the offset value is generated according to the pixel values in the adjacent area of the current block, the adjacent area of the used current block further needs to be obtained.

In some embodiments, the at least one flag bit obtained by decoding the video bitstream may include one or more of the following flag bits: a flag bit included in a sequence header, a flag bit included in an image header, a flag bit included in a slice header, a flag bit included in a coding tree unit (CTU) header, and a flag bit included in a coding block.

In some embodiments, the flag bit included in the sequence header may be configured to indicate whether the coding blocks in the entire sequence use the offset value to adjust the pixel value in the template area, and the mode for exporting the offset value when the pixel value in the template area is adjusted by using the offset value; the flag bit included in the image header may be configured to indicate whether the coding blocks in the entire image use the offset value to adjust the pixel value in the template area, and the mode for exporting the offset value when the pixel value in the template area is adjusted by using the offset value; the flag bit included in the slice header may be configured to indicate whether the coding blocks in the entire slice use the offset value to adjust the pixel value in the template area, and the mode for exporting the offset value when the pixel value in the template area is adjusted by using the offset value; the flag bit included in the CTU header may be configured to indicate whether the coding blocks in the entire CTU use the offset value to adjust the pixel value in the template area, and the mode for exporting the offset value when the pixel value in the template area is adjusted by using the offset value; and the flag bit included in the coding block may be configured to indicate whether the current block uses the offset value to adjust the pixel value in the template area, and the mode for exporting the offset value when the pixel value in the template area is adjusted by using the offset value.

Based on the cross-component prediction method shown in FIG. 6, an embodiment of this disclosure further provides a video coding method. The video coding method may be performed by a device having a computing function, for example, may be performed by a terminal device or a server. A specific process is shown in FIG. 9, including S910 to S940, and is described as follows:
S910: Obtain a pixel value included in a template area adjacent to a current block.
S920: Adjust the pixel value in the template area according to a set offset value to obtain an adjusted pixel value.
S930: Construct a cross-component prediction model corresponding to the current block based on the adjusted pixel value.
S940: Generate a chrominance component predicted value corresponding to the current block according to the cross-component prediction model and a brightness component reconstructed pixel corresponding to the current block, and perform coding processing based on the chrominance component predicted value corresponding to the current block to obtain a coded video bitstream.

For processing details of the operations shown in FIG. 9, refer to the introduction in the foregoing embodiments, and details are not described herein again.

Based on the foregoing, in the technical solutions of the embodiments of this disclosure, an offset value of a particular magnitude may be applied to the pixel value used by the cross-component prediction model, so that when the cross-component prediction model is constructed based on the adjusted pixel value, the precision of the calculated model parameter may be improved, thereby being conducive to improving the accuracy of the cross-component prediction and the performance of video coding and decoding.

An example in which the cross-component prediction model is a CCNPM is taken below to describe implementation details of the technical solutions in the embodiments of this disclosure in further detail.

In an embodiment of this disclosure, corresponding offset values may be respectively subtracted from sample values (i.e., pixel values) of different color components (i.e., Y/U/V) in the template area used by the CCNPM. Then, the prediction model is constructed by using a sample (i.e., pixel) obtained by subtracting the offset value. Finally, when a current chrominance block (i.e., the chrominance component of the current block) is predicted by using the prediction model, an offset value corresponding to the chrominance component is added.

In some embodiments, the cross-component prediction model constructed based on the sample obtained by subtracting the offset value is shown as follows:

$${C}^{″} = {p}_{0} ( \frac{{N}^{′} + {S}^{′} + 4 {C}^{′} + {W}^{′} + {E}^{′}}{8} ) + {p}_{1} ( \frac{{N}^{′} + {W}^{′}}{2} ) + {p}_{2} ( \frac{{N}^{′} + {E}^{′}}{2} ) + {p}_{3} ( \frac{{S}^{′} + {W}^{′}}{2} ) + {p}_{4} ( \frac{{S}^{′} + {E}^{′}}{2} ) + {{p}_{5} ( \frac{{N}^{′} + {S}^{′} + 4 {C}^{′} + {W}^{′} + {E}^{′}}{8} )}^{2} + {p}_{6} B + c\_offset$$

where N′, S′, C′, W′, E′ represents a brightness sample after subtracting a brightness component offset value; C″ represents a target chrominance component sampling point; pᵢ (i.e., p₀, p₁, p₂, p₃, p₄, p₅, and p₆) represents a model parameter, and B represents a constant term; and c_offset represents a chrominance component offset value corresponding to a target chrominance block.

In the foregoing embodiments, values of the sampling points become smaller by subtracting the offset value, so that in a process of solving a model coefficient, both a numerator and a denominator in a formula become smaller. Then, when the division operation is performed, the numerator is further magnified (for example, the numerator is moved leftwards by 22 bits). Therefore, the numerator that is amplified after subtracting the offset has a greater change relative to the denominator, resulting in higher calculation precision.

In some embodiments, in a variant embodiment of this disclosure, a constant term B in the cross-component prediction model constructed based on the sample from which the offset value is subtracted may also be processed by using the offset value. For example, the following cross-component prediction model may be constructed:

$${C}^{″} = {p}_{0} ( \frac{{N}^{′} + {S}^{′} + 4 {C}^{′} + {W}^{′} + {E}^{′}}{8} ) + {p}_{1} ( \frac{{N}^{′} + {W}^{′}}{2} ) + {p}_{2} ( \frac{{N}^{′} + {E}^{′}}{2} ) + {p}_{3} ( \frac{{S}^{′} + {W}^{′}}{2} ) + {p}_{4} ( \frac{{S}^{′} + {E}^{′}}{2} ) + {{p}_{5} ( \frac{{N}^{′} + {S}^{′} + 4 {C}^{′} + {W}^{′} + {E}^{′}}{8} )}^{2} + {p}_{6} {B}^{′} + c\_offset$$

That is, in the foregoing cross-component prediction model, B′ represents a new constant term obtained by performing offset value processing on the constant term B.

In some embodiments, the brightness component offset value and the chrominance component offset value may be the same or may be different. The brightness component offset value and the chrominance component offset value may be exported by using the same exporting method or different exporting methods. For example, the brightness component offset value and the chrominance component offset value may both be fixed constants, for example, integers such as 0, 128, 256, 512, and 1024 and decimals.

In some embodiments, the brightness component offset value and the chrominance component offset value may be determined by using an average value of samples at N locations closely adjacent to the upper left corner of the current block (for the brightness component offset value, an average value of brightness samples at N locations closely adjacent to the upper left corner of the current block is used; and for the chrominance component offset value, an average value of chrominance samples at N locations closely adjacent to the upper left corner of the current block is used, where Nis a positive integer). Similarly, an average value of samples at N locations closely adjacent to the lower left corner of the current block may be used; or an average value of samples at N locations closely adjacent to the upper right corner of the current block is used; or an average value of samples at N locations closely adjacent to the direct upper side of the current block is used; or an average value of samples at N locations closely adjacent to the direct left side of the current block is used; or an average value of samples at N locations spaced apart from the upper left corner of the current block by certain distance is used; or an average value of samples at N locations spaced apart from the lower left corner of the current block by certain distance is used; or an average value of samples at N locations spaced apart from the upper right corner of the current block by certain distance is used. Alternatively, an average value of samples at other locations adjacent to the current block may be used.

In some embodiments, when an offset value is applied to a sample value, in addition to subtracting the corresponding offset value, other modes such as addition, multiplication, and division of the offset value may be used, or the offset value may be substituted into a linear function or a nonlinear function to generate a new offset value for use.

In some embodiments, modes for exporting the chrominance component offset value and the brightness component offset value may be determined in an explicit mode or an implicit mode.

In some embodiments, when an implicit mode is adopted to determine the modes for exporting the chrominance component offset value and the brightness component offset value, the coding side and the decoding side may agree on using the same offset value application method by default. For example, the coding side and the decoding side both subtract a set offset value by default by using a block as a unit, and the offset value is exported from an average value of samples at two locations closely adjacent to the upper left corner of the current block.

In some embodiments, when an explicit mode is adopted to determine the modes for exporting the chrominance component offset value and the brightness component offset value, the coding side may select whether to apply an offset value to the current block, the CTU, the slice, the current frame, or the current sequence through a rate-distortion optimization (RDO) mode, and indicate whether to enable the method by using a transmission flag bit. Furthermore, a flag bit may also be adopted to indicate a method for exporting the offset value when the offset value is applied. The decoding side may determine whether to adjust the pixel value in the template area by using the offset value by parsing a block-level, CTU-level, slice-level, frame-level, or sequence-level flag bit, and determine a mode for exporting the offset value when the pixel value in the template area is adjusted by using the offset value.

The methods provided in the foregoing embodiments of this disclosure may be used alone, or may be used after being combined, and may be applied to template area-based video coding and decoding technologies such as intra, inter, and filtering technologies, and video coder and decoder products.

The following describes apparatus embodiments of this disclosure, and the apparatus embodiments may be configured to perform the methods in the foregoing embodiments of this disclosure. For details not disclosed in the apparatus embodiments of this disclosure, refer to the foregoing method embodiments of this disclosure.

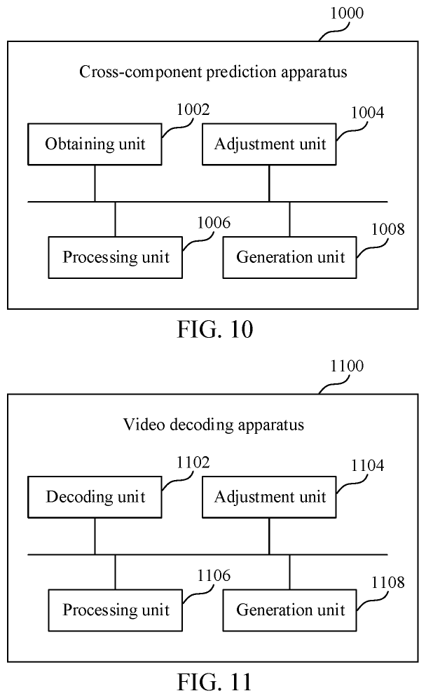

FIG. 10 shows a block diagram of a cross-component prediction apparatus according to an embodiment of this disclosure. The cross-component prediction apparatus may be applied to a video coding device or a video decoding device. The video coding device or the video decoding device may be a terminal device, a server, or the like.

Referring to FIG. 10, a cross-component prediction apparatus 1000 according to an embodiment of this disclosure includes: an obtaining unit 1002, an adjustment unit 1004, a processing unit 1006, and a generation unit 1008.

The obtaining unit 1002 is configured to obtain a pixel value included in a template area adjacent to a current block. The adjustment unit 1004 is configured to adjust the pixel value in the template area according to a set offset value to obtain an adjusted pixel value. The processing unit 1006 is configured to construct a cross-component prediction model corresponding to the current block based on the adjusted pixel value. The generation unit 1008 is configured to generate a chrominance component predicted value corresponding to the current block according to the cross-component prediction model and a brightness component reconstructed pixel corresponding to the current block.

In some embodiments of this disclosure, based on the foregoing solution, the adjustment unit 1004 is further configured to use a set constant value as the offset value; or generate the set offset value according to pixel values in an adjacent area of the current block.

In some embodiments of this disclosure, based on the foregoing solution, the pixel values in the adjacent area include one or more of the following pixel values: a first quantity of pixel values closely adjacent to an upper left corner of the current block; a second quantity of pixel values closely adjacent to a lower left corner of the current block; a third quantity of pixel values closely adjacent to an upper right corner of the current block; a fourth quantity of pixel values closely adjacent to a lower right corner of the current block; a fifth quantity of pixel values closely adjacent to an upper side of the current block; a sixth quantity of pixel values closely adjacent to a left side of the current block; a seventh quantity of pixel values closely adjacent to a right side of the current block; an eighth quantity of pixel values closely adjacent to a lower side of the current block; a ninth quantity of pixel values spaced apart from the upper left corner of the current block by a first set distance; a tenth quantity of pixel values spaced apart from the lower left corner of the current block by a second set distance; an eleventh quantity of pixel values spaced apart from the upper right corner of the current block by a third set distance; a twelfth quantity of pixel values spaced apart from the lower right corner of the current block by a fourth set distance; a thirteenth quantity of pixel values spaced apart from the upper side of the current block by a fifth set distance; a fourteenth quantity of pixel values spaced apart from the left side of the current block by a sixth set distance; a fifteenth quantity of pixel values spaced apart from the right side of the current block by a seventh set distance; and a sixteenth quantity of pixel values spaced apart from the lower side of the current block by an eighth set distance.

In some embodiments of this disclosure, based on the foregoing solution, the adjustment unit 1004 is configured to calculate an average pixel value in the adjacent area of the current block, and use the calculated average pixel value as the offset value.

In some embodiments of this disclosure, based on the foregoing solution, the adjustment unit 1004 is configured to: perform a mathematical operation on the pixel value in the template area by using the offset value to obtain the adjusted pixel value; or

adjust the set offset value to obtain a new offset value, and adjust the pixel value in the template area by using the new offset value to obtain the adjusted pixel value.

In some embodiments of this disclosure, based on the foregoing solution, the adjustment unit 1004 is configured to: perform linear adjustment on the offset value based on a set linear function to obtain the new offset value; or perform nonlinear adjustment on the offset value based on a set nonlinear function to obtain the new offset value.

In some embodiments of this disclosure, based on the foregoing solution, the set offset value includes a brightness component offset value and a chrominance component offset value. The adjustment unit 1004 is configured to adjust a brightness component pixel value in the template area according to the brightness component offset value, and adjust a chrominance component pixel value in the template area according to the chrominance component offset value.

In some embodiments of this disclosure, based on the foregoing solution, the generation unit 1008 is configured to input the brightness component reconstructed pixel corresponding to the current block to the cross-component prediction model, if the cross-component prediction model includes the chrominance component offset value, to obtain the chrominance component predicted value corresponding to the current block outputted by the cross-component prediction model; or input the brightness component reconstructed pixel corresponding to the current block to the cross-component prediction model, if the cross-component prediction model does not include the chrominance component offset value, to generate the chrominance component predicted value corresponding to the current block based on the chrominance component offset value and a predicted value outputted by the cross-component prediction model.

In some embodiments of this disclosure, based on the foregoing solution, the cross-component prediction model includes any one of the following: a cross-component nonlinear prediction model for intra prediction, a cross-component linear prediction model for intra prediction, a cross-component nonlinear prediction model for inter prediction, and a cross-component linear prediction model for inter prediction.

FIG. 11 shows a block diagram of a video decoding apparatus according to an embodiment of this disclosure. The video decoding apparatus may be applied to a device having a computing function, for example, may be applied to a terminal device or a server.

Referring to FIG. 11, a video decoding apparatus 1100 according to an embodiment of this disclosure includes: a decoding unit 1102, an adjustment unit 1104, a processing unit 1106, and a generation unit 1108.

The decoding unit 1102 is configured to decode a video bitstream to obtain a pixel value included in a template area adjacent to a current block. The adjustment unit 1104 is configured to adjust the pixel value in the template area according to a set offset value to obtain an adjusted pixel value. The processing unit 1106 is configured to construct a cross-component prediction model corresponding to the current block based on the adjusted pixel value. The generation unit 1108 is configured to generate a chrominance component predicted value corresponding to the current block according to the cross-component prediction model and a brightness component reconstructed pixel corresponding to the current block, and perform decoding processing based on the chrominance component predicted value corresponding to the current block.

In some embodiments of this disclosure, based on the foregoing solution, the adjustment unit 1104 is further configured to: determine a mode for exporting the offset value according to a mode negotiated with a coding side; or decode the video bitstream to obtain at least one flag bit, determine whether to adjust the pixel value in the template area by using the offset value according to a value of the at least one flag bit, and determine a mode for exporting the offset value when the pixel value in the template area is adjusted by using the offset value.

In some embodiments of this disclosure, based on the foregoing solution, the at least one flag bit includes one or more of the following flag bits: a flag bit included in a sequence header, a flag bit included in an image header, a flag bit included in a slice header, a flag bit included in a coding tree unit (CTU) header, and a flag bit included in a coding block.

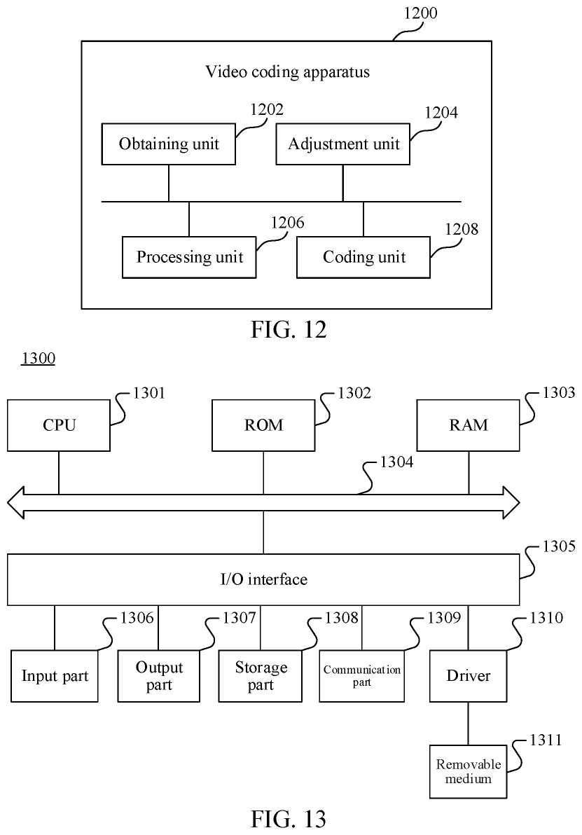

FIG. 12 shows a block diagram of a video coding apparatus according to an embodiment of this disclosure. The video coding apparatus may be applied to a device having a computing function, for example, may be applied to a terminal device or a server.

Referring to FIG. 12, a video coding apparatus 1200 according to an embodiment of this disclosure includes: an obtaining unit 1202, an adjustment unit 1204, a processing unit 1206, and a coding unit 1208.

The obtaining unit 1202 is configured to obtain a pixel value included in a template area adjacent to a current block. The adjustment unit 1204 is configured to adjust the pixel value in the template area according to a set offset value to obtain an adjusted pixel value. The processing unit 1206 is configured to construct a cross-component prediction model corresponding to the current block based on the adjusted pixel value. The coding unit 1208 is configured to generate a chrominance component predicted value corresponding to the current block according to the cross-component prediction model and a brightness component reconstructed pixel corresponding to the current block, and perform coding processing based on the chrominance component predicted value corresponding to the current block to obtain a coded video bitstream.

FIG. 13 shows a schematic structural diagram of a computer system suitable for implementing an electronic device according to an embodiment of this disclosure. The electronic device may be the cross-component prediction apparatus, the video coding device, or the video decoding device in the foregoing embodiments.

The computer system 1300 of the electronic device shown in FIG. 13 is an example, and does not constitute any limitation on the function and scope of use of the embodiments of this disclosure.

As shown in FIG. 13, the computer system 1300 may include a central processing unit (CPU) 1301, which may perform various suitable actions and processes according to a program stored in a read-only memory (ROM) 1302 or a program loaded from a storage part 1308 into a random access memory (RAM) 1303, for example, may perform the methods in the foregoing embodiments. The RAM 1303 further has various programs and data required for system operation stored therein. The CPU 1301, the ROM 1302, and the RAM 1303 are connected to each other through a bus 1304. An input/output (I/O) interface 1305 is also connected to the bus 1304.

The following components may be connected to the I/O interface 1305: an input part 1306 including a keyboard, a mouse, or the like; an output part 1307 including a cathode ray tube (CRT), a liquid crystal display (LCD), a speaker, or the like; a storage part 1308 including a hard disk, or the like; and a communication part 1309 including a network interface card such as a local area network (LAN) card or a modem. The communication part 1309 performs communication processing by using a network such as the Internet. A driver 1310 is also connected to the I/O interface 1305 as required. A removable medium 1311 such as a magnetic disk, an optical disk, a magneto-optical disk, or a semiconductor memory is installed on the driver 1310 as required, so that a computer program read from the removable medium is installed into the storage part 1308 as required.

For example, according to the embodiments of this disclosure, the process described in the foregoing reference flowchart may be implemented as a computer software program. For example, an embodiment of this disclosure includes a computer program product. The computer program product includes a computer program carried on a computer-readable medium, and the computer program is configured for performing the methods shown in the flowcharts. In such an embodiment, the computer program may be downloaded and installed from a network through the communication part 1309, and/or installed from the removable medium 1311. When the computer program is executed by the CPU 1301, various functions defined in the system of this disclosure are performed.

The computer-readable medium described in the embodiments of this disclosure may be a computer-readable signal medium, or a computer-readable storage medium, or any combination of the above. The computer-readable storage medium may be, for example (but is not limited to) an electric, magnetic, optical, electromagnetic, infrared, or semi-conductive system, apparatus, or device, or any combination of the above. More specific examples of the computer-readable storage medium may include, but are not limited to: an electrical connection having one or more wires, a portable computer disk, a hard disk, a RAM, a ROM, an erasable programmable read only memory (EPROM), a flash memory, an optical fiber, a portable compact disc read-only memory (CD-ROM), an optical storage device, a magnetic storage device, or any appropriate combination of the above. In this disclosure, the computer-readable storage medium may be any tangible medium including or storing a computer program. The computer program may be used by or in combination with an instruction execution system, apparatus, or device. In this disclosure, the computer-readable signal medium may include a data signal propagated in a baseband or as a part of a carrier wave, which carries a computer-readable computer program. A data signal propagated in such a way may adopt a plurality of forms, including, but not limited to, an electromagnetic signal, an optical signal, or any suitable combination thereof. The computer-readable signal medium may further be any computer-readable medium other than the computer-readable storage medium. The computer-readable medium may transmit, propagate, or transfer a program used by or in combination with the instruction execution system, apparatus, or device. The computer program included in the computer-readable medium may be transmitted by using any suitable medium, including but not limited to: a wireless medium, a wired medium, or any suitable combination thereof.

The flowcharts and block diagrams in the accompanying drawings illustrate possible system architectures, functions and operations that may be implemented by a system, a method, and a computer program product according to various embodiments of this disclosure. Each block in the flowchart or the block diagram may represent a module, a program segment, or a part of code. The module, the program segment, or the part of the code includes one or more executable instructions for implementing a specified logical function. In some alternative implementations, functions annotated in the blocks may also be executed in a different order from those annotated in the accompanying drawings. For example, two blocks shown in succession may actually be performed basically in parallel, and sometimes the two blocks may be performed in a reverse order. This depends on the functions involved. Each block in the block diagrams or the flowcharts and combinations of blocks in the block diagrams or the flowcharts may be implemented by a dedicated hardware-based system that performs specified functions or operations, or may be implemented by a combination of dedicated hardware and a computer program.

Related units described in the embodiments of this disclosure may be implemented in a software mode, or may be implemented in a hardware mode, or the described units may be disposed in a processor. Names of these units do not constitute a limitation on the units in some cases.

As another aspect, this disclosure further provides a computer-readable medium. The computer-readable medium may be included in the electronic device described in the foregoing embodiments, or may exist alone and is not assembled into the electronic device. The foregoing computer-readable medium carries one or more computer programs, and the one or more computer programs, when executed by an electronic device, causes the electronic device to implement the methods described in the foregoing embodiments.

Although a plurality of modules or units of a device configured to perform actions are mentioned in the foregoing detailed description, such partition is not mandatory. In fact, according to the implementations of this disclosure, the features and functions of two or more modules or units described above may be embodied in one module or unit. On the contrary, the features and functions of one module or unit described above may further be partitioned to be embodied by a plurality of modules or units.

Through the foregoing descriptions of the implementations, the implementations described herein may be implemented by software, or may be implemented by combining software with necessary hardware. Therefore, the technical solutions according to the implementations of this disclosure may be embodied in a form of a software product. The software product may be stored in a non-volatile storage medium (which may be a CD-ROM, a USB flash drive, a removable hard disk, or the like) or on the network, including several instructions for enabling an electronic device to perform the methods according to the implementations of this disclosure.

For example, the electronic device may be a cross-component prediction apparatus, and then, the cross-component prediction apparatus may perform the cross-component prediction method shown in FIG. 6. For another example, the electronic device may be a video decoding device, and then, the video decoding device may perform the video decoding method shown in FIG. 8. For another example, the electronic device may be a video coding device, and then, the video coding device may perform the video coding method shown in FIG. 9.

In the technical solutions provided in some embodiments of this disclosure, after a pixel value included in a template area adjacent to a current block is obtained, the pixel value in the template area may be adjusted according to a set offset value to obtain an adjusted pixel value, and then, a cross-component prediction model corresponding to the current block is constructed based on the adjusted pixel value, and a chrominance component predicted value corresponding to the current block is generated according to the cross-component prediction model and a brightness component reconstructed pixel corresponding to the current block, so that an offset value of a particular magnitude may be applied to a pixel value used by the cross-component prediction model. Therefore, when the cross-component prediction model is constructed based on the adjusted pixel value, the precision of the calculated model parameter may be improved, thereby being conducive to improving the accuracy of the cross-component prediction and the performance of video coding and decoding.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of cross-component prediction, comprising:
obtaining pixel values in a template area adjacent to a current block;
adjusting the pixel values in the template area according to an offset value to obtain adjusted pixel values;
constructing a cross-component prediction model for the current block based on the adjusted pixel values, model parameters of the cross-component prediction model being calculated based on division operations with numerators being left shifted a fixed number of bits; and
generating at least a chrominance component value of a pixel in the current block according to the cross-component prediction model and reconstructed luminance component values of one or more pixels associated with the pixel in the current block.

2. The method according to claim 1, further comprising:
using a constant value as the offset value; or
generating the offset value according to pixel values of neighboring pixels in an adjacent area of the current block.

3. The method according to claim 2, wherein the neighboring pixels in the adjacent area comprise one or more of:
a first quantity of pixels immediately adjacent to an upper left corner of the current block;
a second quantity of pixels immediately adjacent to a lower left corner of the current block;
a third quantity of pixels immediately adjacent to an upper right corner of the current block;
a fourth quantity of pixels immediately adjacent to a lower right corner of the current block;
a fifth quantity of pixels that are immediately adjacent to an upper side of the current block;
a sixth quantity of pixels that are immediately adjacent to a left side of the current block;
a seventh quantity of pixels that are immediately adjacent to a right side of the current block;
an eighth quantity of pixels that are immediately adjacent to a lower side of the current block;
a ninth quantity of pixels spaced apart from the upper left corner of the current block by a first distance;
a tenth quantity of pixels spaced apart from the lower left corner of the current block by a second distance;
an eleventh quantity of pixels spaced apart from the upper right corner of the current block by a third distance;
a twelfth quantity of pixels spaced apart from the lower right corner of the current block by a fourth distance;
a thirteenth quantity of pixels spaced apart from the upper side of the current block by a fifth distance;
a fourteenth quantity of pixels spaced apart from the left side of the current block by a sixth distance;
a fifteenth quantity of pixels spaced apart from the right side of the current block by a seventh distance; and
a sixteenth quantity of pixels spaced apart from the lower side of the current block by an eighth distance.

4. The method according to claim 2, wherein the generating the offset value comprises at least one of:
calculating the offset value as an average pixel value in the adjacent area of the current block;
calculating the offset value as a weighted sum of the pixel values in the adjacent area of the current block; or
using a median of the pixel values in the adjacent area of the current block as the offset value.

5. The method according to claim 1, wherein the adjusting the pixel values in the template area comprises at least one of:
performing a mathematical operation on the pixel values in the template area based on the offset value to obtain the adjusted pixel values; or
adjusting the pixel values in the template area by using a new offset value that is obtained based on an adjustment of the offset value.

6. The method according to claim 5, further comprising at least one of:
performing a linear adjustment on the offset value based on a linear function to obtain the new offset value; or
performing a nonlinear adjustment on the offset value based on a nonlinear function to obtain the new offset value.

7. The method according to claim 1, wherein:
the offset value comprises a luminance component offset value and a chrominance component offset value; and
the adjusting the pixel values in the template area comprises:
adjusting a luminance component pixel value of a pixel in the template area according to the luminance component offset value, and
adjusting a chrominance component pixel value of the pixel in the template area according to the chrominance component offset value.

8. The method according to claim 7, wherein the generating the chrominance component value of the pixel in the current block comprises:
when the cross-component prediction model comprises the chrominance component offset value, inputting the reconstructed luminance component values of the one or more pixels to the cross-component prediction model to cause the cross-component prediction model to output the chrominance component value of the pixel.

9. The method according to claim 7, wherein the generating the chrominance component value of the pixel in the current block comprises:
when the cross-component prediction model does not comprise the chrominance component offset value,
inputting the reconstructed luminance component values of the one or more pixels to the cross-component prediction model to cause the cross-component prediction model to output a predicted value; and
generating the chrominance component value of the pixel based on the chrominance component offset value and the predicted value outputted by the cross-component prediction model.

10. The method according to claim 1, wherein the cross-component prediction model comprises at least one of:
a cross-component nonlinear prediction model for intra prediction,
a cross-component linear prediction model for intra prediction,
a cross-component nonlinear prediction model for inter prediction, or
a cross-component linear prediction model for inter prediction.

11. A method of video decoding, comprising:
receiving a video bitstream comprising coded information of a current block;
obtaining pixel values in a template area adjacent to the current block;
adjusting the pixel values in the template area according to an offset value to obtain adjusted pixel values;
constructing a cross-component prediction model for the current block based on the adjusted pixel values, model parameters of the cross-component prediction model being calculated based on division operations with numerators being left shifted a fixed number of bits; and
generating at least a chrominance component value of a pixel in the current block according to the cross-component prediction model and reconstructed luminance component values of one or more pixels associated with the pixel in the current block.

12. The method according to claim 11, further comprising:
determining a derivation mode for the offset value according to a mode that is negotiated with a coding side of the video bitstream.

13. The method according to claim 11, further comprising:
decoding the video bitstream to obtain at least a flag;
determining, according to at least the flag, whether to adjust the pixel values in the template area by using the offset value; and
determining, when at least the flag indicates to adjust the pixel values in the template area by using the offset value, a derivation mode for the offset value.

14. The method according to claim 13, wherein at least the flag comprises one or more of:
a flag in a sequence header,
a flag in an image header,
a flag in a slice header,
a flag in a coding tree unit (CTU) header, and
a flag in a coding block.

15. The method according to claim 11, further comprising:
using a constant value as the offset value; or
generating the offset value according to pixel values of neighboring pixels in an adjacent area of the current block.

16. The method according to claim 15, wherein the generating the offset value comprises at least one of:
calculating the offset value as an average pixel value in the adjacent area of the current block;
calculating the offset value as a weighted sum of the pixel values in the adjacent area of the current block; or
using a median of the pixel values in the adjacent area of the current block as the offset value.

17. The method according to claim 11, wherein the cross-component prediction model comprises at least one of:
a cross-component nonlinear prediction model for intra prediction,
a cross-component linear prediction model for intra prediction,
a cross-component nonlinear prediction model for inter prediction, or
a cross-component linear prediction model for inter prediction.

18. A method of video encoding, comprising:
obtaining pixel values in a template area adjacent to a current block;
adjusting the pixel values in the template area according to an offset value to obtain adjusted pixel values;
constructing a cross-component prediction model for the current block based on the adjusted pixel values, model parameters of the cross-component prediction model being calculated based on division operations with numerators being left shifted a fixed number of bits;
generating at least a chrominance component value of a pixel in the current block according to the cross-component prediction model and reconstructed luminance component values of one or more pixels associated with the pixel in the current block; and
encoding the current block into coded information in a video bitstream based on at least the chrominance component value of the pixel in the current block.

19. The method according to claim 18, further comprising:
using a constant value as the offset value; or
generating the offset value according to pixel values of neighboring pixels in an adjacent area of the current block.

20. The method according to claim 18, wherein the cross-component prediction model comprises at least one of:
a cross-component nonlinear prediction model for intra prediction,
a cross-component linear prediction model for intra prediction,
a cross-component nonlinear prediction model for inter prediction, or
a cross-component linear prediction model for inter prediction.
